(19) United States
(12) Patent Application Publication
(10) Pub. No.: US 2016/0075404 A1
(43) Pub. Date: Mar. 17, 2016

(54) METHOD FOR THE SAFE OPERATION OF A SNOWMOBILE

(71) Applicant: Robert Bosch GmbH, Stuttgart (DE)

(72) Inventors: Jonathan HAAF, Limbach (DE); Michael Lee PARKER, Esslingen Am Neckar (DE)

(21) Appl. No.: 14/804,429

(22) Filed: Jul. 21, 2015

(30) Foreign Application Priority Data
Jul. 25, 2014 (DE) 10 2014 214 643.7

(51) Int. Cl. B62M 27/02

(52) U.S. Cl. CPC B62M 27/02; B62M 2027/026

(57) ABSTRACT

A method for operating a snowmobile, measured values of measured variables of the snowmobile being determined in the continuous operation of the snowmobile, specific measured values of different combinations of individual measured variables of the snowmobile being evaluated on the basis of evaluation criteria to determine whether the snowmobile is being operated in an unstable driving state and a stabilizing countermeasure being taken if it is determined that the snowmobile is being operated in an unstable driving state.

### FIELD OF THE INVENTION

The present invention relates to a method for operating a snowmobile, measured values of measured variables of the snowmobile being determined while the snowmobile is in continuous operation.

### BACKGROUND INFORMATION

Snowmobile is the name commonly used for track-type vehicles for movement in snow. Snowmobiles are often operated in non-prepared, uneven and steep terrain. Characteristics of the terrain can often change quickly, it being possible for example that a gradient of the terrain changes abruptly.

The operation of a snowmobile is very demanding and dangerous even for experienced drivers. The snowmobile can quickly enter an unstable, stability-critical or unsafe driving state. Such unstable driving states can result in the driver losing control of the snowmobile. As a consequence, the snowmobile may tip over or even roll over.

It is therefore desirable to indicate a possibility for reducing the risk of such unstable driving states when operating a snowmobile.

### SUMMARY OF THE INVENTION

The present invention provides a method for operating a snowmobile having the features described herein. Advantageous refinements are the subject matter of the following further descriptions.

A snowmobile is designed in particular as a track-type vehicle and further has in particular a suitable drive, which provides a drive torque. Such a drive may be configured for example as an internal combustion engine or as an electric motor. This drive torque is transmitted to a track drive shaft via a transmission, for example a stepless transmission (continuously variable transmission, CVT transmission). A snowmobile is operated in particular in snow or on a snow-covered terrain, in particular on a non-prepared terrain. Furthermore, a snowmobile is operated in particular on an alpine or mountainous terrain.

In continuous operation of the snowmobile, measured values of measured variables of the snowmobile are determined. In particular, such measured values are detected directly as sensor values by suitable sensors. Furthermore, such measured values are in particular determined or calculated from sensor values detected by suitable sensors.

According to the present invention, different combinations of individual measured variables are evaluated. The measured values, determined in continuous operation of the snowmobile, of the individual measured variables of these different combinations of measured variables are evaluated on the basis of evaluation criteria with the aim of determining whether the snowmobile is being operated in an unstable, stability-critical or unsafe driving state.

Such an unstable driving state is to be understood in particular as a state in which the snowmobile is operated in such a way that there exists an increased risk of an accident or that there is the risk that the driver loses control of the snowmobile. As a consequence of such unstable driving states, the snowmobile can tip over or roll over. In particular, the determined measured values of the different combinations of measured variables are evaluated on the basis of the evaluation criteria with the aim of determining whether there is the risk that the snowmobile tips over or rolls over.

If the evaluation establishes that the snowmobile is being operated in such an unstable driving state, then a stabilizing countermeasure is taken. This stabilizing countermeasure (actively) counteracts the unstable driving state. In particular, handling characteristics are stabilized by this stabilizing countermeasure, i.e. the movement of the snowmobile is stabilized. The risk of an accident is in particular reduced. Furthermore, in particular the risk is reduced that the driver loses control of the snowmobile or that the snowmobile tips over or rolls over.

By evaluating or weighting one or multiple combinations of individual measured variables in accordance with the present invention, it is possible to detect an unstable driving state of the snowmobile particularly effectively and reliably. Unstable driving states may be detected or determined early, already in their formative phase. It is thus possible to counteract unstable driving states so as to prevent an accident, an overturning or rollover of the snowmobile.

By evaluating individual measured variables discretely and independently of one another, it is hardly possible or not possible at all to detect unstable driving states reliably. According to the present invention, by contrast, individual measured variables are combined skillfully and suitably and are evaluated jointly or in dependence on one another so that by this evaluation of the combination it is possible to assess whether or not an unstable driving state exists.

The same measured variable may assessed in particular in multiple different combinations, respectively using different additional measured variables. Thus, specific measured values of a specific measured variable may be evaluated in multiple combinations respectively on the basis of different evaluation criteria. In each of these different combinations, different evaluation criteria (specific to the respective combination) may be selected in each case for the same measured variable.

The evaluation criteria are selected in particular in such a way that it is possible to infer a specific unstable driving state from the respective combination of measured variables. In particular, individual measured variables of the snowmobile are grouped into different combinations or the different combinations of individual measured variables are chosen in such a way that it is possible to infer a specific unstable driving state from each of these combinations.

By evaluating different combinations of individual measured variables, it is possible in particular to infer respectively different unstable driving states. For example, using a first combination of measured variables, it is possible to assess whether a first unstable driving state bears the risk that the snowmobile tips over to the left. By way of further combinations of measured variables, it is possible to assess for example whether a respective unstable driving state bears the risk that the snowmobile tips over to the right or rolls over.

According to the present invention, individual measured variables are grouped into different combinations in such a way, and respective evaluation criteria of these different combinations are selected in such a way that it is possible to assess reliable whether an unstable driving state exists or whether there exists an increased risk of an accident or whether there is an increased risk that the snowmobile tips over or rolls over.

The evaluation criteria take into account in particular specific characteristics or a specific behavior (handling, cornering behavior) of a specific snowmobile. In particular, different evaluation criteria are selected for different snowmobiles or for different series, models or classes of snowmobiles. Such specific characteristics are for example weight, center of gravity, tread width, height, width, length and/or ground clearance of the snowmobile.

This grouping of individual measured variable into different combinations and the selection of the respective evaluation criteria in particular provides a theoretical model of the snowmobile. On the basis of this model, it is possible to extrapolate or simulate reliably whether an accident, overturning or rollover of the snowmobile results if the snowmobile continues to be operated without change. An evaluation is performed on the basis of this model as to when, or upon the reaching of which different measured values, a corresponding stabilizing countermeasure is carried out in order to prevent an imminent accident, an imminent turnover or an imminent rollover.

For example, on the basis of this combination of measured variables and the respective evaluation criteria, it is possible to assess whether the snowmobile is accelerated too quickly, whether the snowmobile is moving too quickly on a steep slope or whether a curve is driven too sharply.

The method according to the present invention may be implemented by a control unit of the snowmobile. Thus it is possible to retrofit snowmobiles in a simple manner. Furthermore, a special processing unit may also be provided for carrying out the method of the present invention. Such a processing unit is configured in particular as a microcontroller or an ASIC (application-specific integrated circuit).

The measured values for the individual measured variables are usually determined anyway in the continuous operation of the snowmobile and are usually available in control units of the snowmobile. For this purpose, in particular sensor values of sensors or microsystems (microelectromechanical system, MEMS) are detected in the snowmobile and are transmitted via a suitable communication system (e.g. a field bus system, in particular a CAN bus system) to control units of the snowmobile.

At this point it should be noted that the present invention is equally suitable for other vehicles, particularly for vehicle that are operated on rough terrain that is not prepared. The present invention, for example, is analogously suitable for ATVs (all terrain vehicle), quads or jetskis.

According to an embodiment of the present invention, each of the individual measured variables of the different combinations of individual measured variables has assigned to it respectively one threshold value that is specific to the respective combination. For this purpose, a different threshold value may be respectively assigned to the same measured variable in different combinations. Furthermore, the determined measured values of the different combinations of individual measured variables may be evaluated on the basis of the evaluation criteria in that a check is performed to determine whether the determined measured values of the individual measured variables of the different combinations respectively reach the associated combination-specific threshold values.

An assessment may be made that the snowmobile is operated in an unstable driving state if the determined measured values of the individual measured variables of one of the different groups respectively reach the associated combination-specific threshold values.

It is also possible for multiple combination-specific threshold values to be respectively assigned to the measured variables of a combination. It is thus possible to define different risk ranges or risk levels. Depending on which measured variables of a combination reach which threshold value, stabilizing countermeasures of different levels of intensity may be implemented.

Such multiple combination-specific threshold values may also be used in particular to define different driving modes or operating modes of the snowmobile. For example, a safe driving mode may be defined by selecting comparatively low threshold values. Using comparatively high threshold values, a sporty driving mode may be defined, for example. For example, a driver may switch between these different driving modes, using a switch for example. Depending on the switch position, the corresponding threshold values are used accordingly to evaluate the determined measured values.

Advantageously, as a stabilizing countermeasure, components of the snowmobile are controlled in such a way that they counteract the unstable driving state. For this purpose, an intervention is made in particular into the control system of the snowmobile, or a control unit of the snowmobile controls the component accordingly. In particular, the evaluation criteria are used to determine with what intensity the components are controlled. Depending on the severity of the unstable driving state, the components are controlled with more or less intensity. Alternatively or additionally, an acoustic and/or visual warning message may be output as a stabilizing countermeasure, for example by activating a warning light on an instrument panel of the snowmobile.

A drive torque provided by a drive of the snowmobile may be limited, or a maximum value may be specified for the drive torque as a stabilizing countermeasure. In particular, a rotational speed of a drive configured as an internal combustion engine or an electric motor for example is limited, or a maximum value is specified for the rotational speed. Furthermore, in particular a voltage or a drive current applied to a drive configured as an electric motor is limited. Furthermore, the generated output of the drive may also be reduced directly, for example in that the rotational speed or the applied voltage or the current are reduced directly. In particular, a maximum speed, or even an actual speed of the snowmobile is reduced in this manner. It is also possible for a brake of the snowmobile to be actuated.

Furthermore, a spring suspension of the snowmobile may be adjusted, directed, changed or controlled. In particular, the spring suspension is adjusted in such a way that the snowmobile is raised and/or lowered on one side. If there is the risk, for example, that the snowmobile tips over to the left, the spring suspension is adjusted in particular in such a way that the left side of the snowmobile is raised and/or the right side of the snowmobile is lowered.

Furthermore, a steering direction of the snowmobile may be limited. In particular, a turning radius may also be limited. If there is the risk, for example, that the snowmobile tips over to the left, the steering direction or the turning radius are limited in such a way that the driver is unable to perform a sharp left turn.

Measured values of movement-specific measured variables may be determined. Such movement-specific measured variables describe a movement of the snowmobile or driving parameters of the snowmobile.

Such movement-specific measured variables are in particular a speed of the snowmobile, a drive torque provided by a drive of the snowmobile, a rotational speed of the drive (e.g. internal combustion engine or electric motor), a voltage or a drive current applied to an electric motor, a steering directions and/or a turning radius. Furthermore, such a movement-specific measured variable may be in particular an acceleration, more specifically linear accelerations in the three spatial directions. Measured values for such accelerations are determined in particular as sensor values by suitable acceleration sensors.

From such sensor values, it is also possible to determine in particular measured values for a direction of movement or for the movement of the snowmobile as a measured variable. This direction of movement or this movement may in particular describe how the snowmobile moves relative to a slope or a gradient, for example uphill, downhill or crosswise with respect to the gradient. The direction of movement or movement may in particular describe the specific value of the gradient on which the snowmobile is moving.

Alternatively or additionally, measured values of orientation-specific measured variables may be determined. Such orientation-specific measured variables describe in particular a spatial orientation or alignment of the snowmobile, and furthermore particularly how the snowmobile is oriented with respect to the ground. Such measured variables are in particular an angle of inclination of the snowmobile with respect to a defined axis and/or a rate of rotation, that is, a roll rate, pitch rate and yaw rate, furthermore in particular corresponding roll angles, pitch angles and yaw angles. Corresponding measured values are determined in particular as sensor values from suitable rate-of-rotation sensors.

Alternatively or additionally, measured values of terrain-specific measured variables may be determined. Such terrain-specific measured variables describe a terrain on which the snowmobile is operated. Such measured variables are in particular a terrain gradient and/or a condition of the ground, for example whether the ground below the snowmobile is snow or ice. In order to determine measured values of such measured variables, it is possible in particular to analyze GPS information. Furthermore, such GPS information may be used to analyze in particular topographical map information or map data. Such map information or map data may be stored for example in a control unit of the snowmobile.

Alternatively or additionally, measured values of load-specific measured variables may be determined. Such load-specific measured variables describe loads that act on the snowmobile. These loads may act on the snowmobile particularly by the movement of the snowmobile on the relevant terrain. These loads may also be exerted on the snowmobile by a driver, by a passenger or luggage or freight. Such load-specific measured variables take into account in particular how a driver shifts his body weight on the snowmobile. What is thus taken into account is in particular whether and by how much the driver shifts his body weight in a curve.

If, for example, measured variables such as the steering direction, the direction of movement and the rotational speed of the drive of the snowmobile were evaluated independently of one another, then it is hardly possible or not at all possible to detect an unstable driving state. If, for example, as the measured value for the steering direction it is determined that the snowmobile is making a sharp left turn, as the measured value for the direction of movement it is determined that the snowmobile is moving uphill along a steep gradient and as the measured value for the rotational speed it is determined that the rotational speed increases sharply, then from these three measured values taken in isolation, it is not possible reliably to assess whether or not an unstable driving state exists.

If, however, the combination of these three measured values is evaluated, then in this concrete case an inference may be made for example that the snowmobile is driving at a high, rising speed on a steep stretch uphill in a sharp left curve, in which maneuver there exists an increased risk of an accident. In this situation there exists the risk, for example, that the snowmobile tips over to the left. By evaluating the combination of these measured variables in accordance with a specific embodiment of the present invention, it is thus possible to infer an unstable driving state early, and a suitable stabilizing countermeasure may be taken.

Advantageously, the grouping of measured variables into the different combinations and/or the evaluation criteria of the different combinations are determined experimentally and/or theoretically in the course of a manufacturing process of the snowmobile. In the course of the manufacturing process or in the course of a test phase of the snowmobile, it is possible for example intentionally to bring about various unstable driving states. The snowmobile may be operated in such a manner for example that it tips over or rolls over. In the course of this event, measured values may be determined and analyzed. In the process, an evaluation may be performed as to which specific combinations of measured variables or which specific measured values of different measured variables indicate the respective unstable driving state. Alternatively, the combinations or the evaluation criteria may also be ascertained theoretically, for example, by way of a simulation in a computer.

Advantageously, the grouping of the measured variables into the different combinations and/or the evaluations criteria are determined or learned in the course of the continuous operation of the snowmobile. The evaluation criteria in particular may be updated and improved in the process in the continuous operation of the snowmobile.

A processing unit according to the present invention, e.g. a control unit of a snowmobile, is equipped, particularly in terms of program technology, to carry out a method according to the present invention.

The implementation of the method in the form of software is also advantageous, since this incurs particularly low costs, especially if an executing control unit is also used for other tasks and is therefore present anyway. Suitable data carriers for providing the computer program are, in particular, diskettes, hard disks, flash memories, EEPROMs, CD-ROMs, DVDs, etc. A download of a program via computer networks (Internet, intranet, etc.) is also possible.

Further advantages and configurations of the present invention derive from the description and the enclosed drawings.

It is understood that the features mentioned above and the features yet to be explained below may be used not only in the combination indicated in each case but also in other combinations or in isolation, without departing from the scope of the present invention.

The present invention is represented schematically in the drawing on the basis of exemplary embodiments and described in detail below with reference to the drawings.

### BRIEF DESCRIPTION OF THE DRAWINGS

FIG. 1A shows schematically a snowmobile that is designed to carry out a specific embodiment of a method according to the present invention.

FIG. 1B shows schematically a snowmobile that is designed to carry out a specific embodiment of a method according to the present invention.

FIG. 2 shows schematically a specific embodiment of a method according to the present invention as a block diagram.

### DETAILED DESCRIPTION

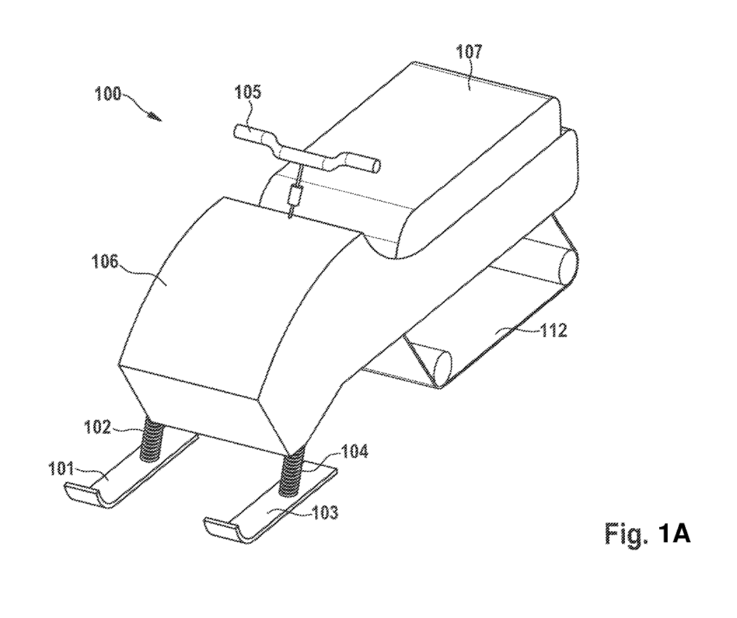

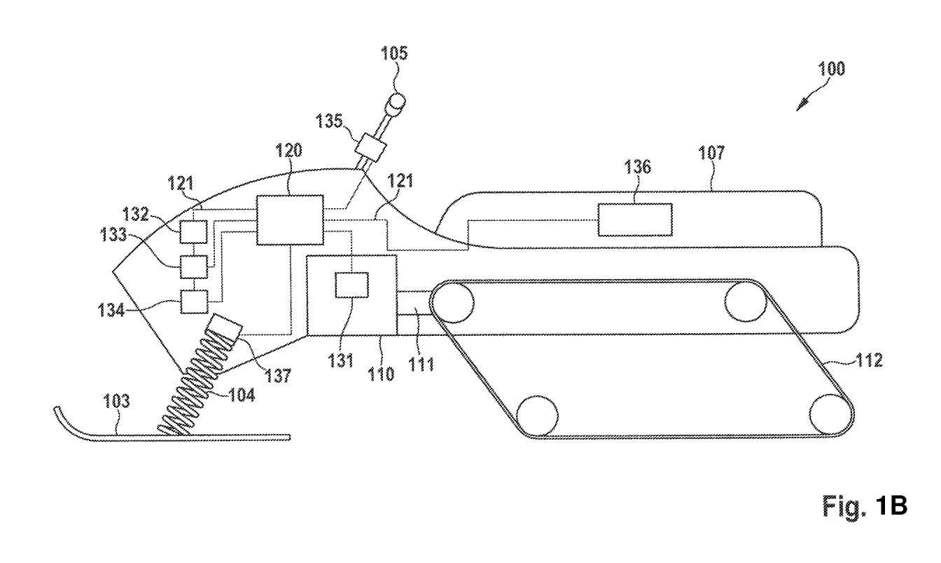

FIG. 1 schematically shows a snowmobile which is indicated by reference numeral 100. FIG. 1a schematically shows snowmobile 100 in a perspective view, while FIG. 1b shows it in a side view.

The snowmobile has two skis 101 and 103. Each ski 101 and 103 is connected to a frame or housing 106 of snowmobile 100 via a respective spring or suspension 102 and 104. Skis 101 and 103 may be oriented via a steering 105, and thus a steering direction may be specified.

The snowmobile furthermore has a drive 110. In this example, the drive is configured as an internal combustion engine 110. Internal combustion engine 110 provides a drive torque that is transmitted via a transmission 111, for example a continuously variable transmission, to a track drive shaft. The drive torque is thus transmitted to a track 112 of snowmobile 100.

Snowmobile 100 furthermore has a control unit 120. Furthermore, a communication system, for example a CAN bus 121, is implemented in snowmobile 100. Control unit 120 is connected to various sensors and actuators via this CAN bus 121.

For example, a rotational speed sensor 131 (for example an incremental encoder) is situated in internal combustion engine 110. Furthermore, rate-of-rotation sensors 132 or gyroscopic sensors 132 as well as linear acceleration sensors 133 are provided, which together represent an inertial sensor system. Rate-of-rotation sensors 132 may be also configured for determining the angles of rotation. Separate angle-of-rotation sensors may also be provided. Furthermore, a GPS sensor 134 is also present. A steering sensor 135 is situated in steering 105, and a weight sensor 136 is situated in seat 107 of the snowmobile.

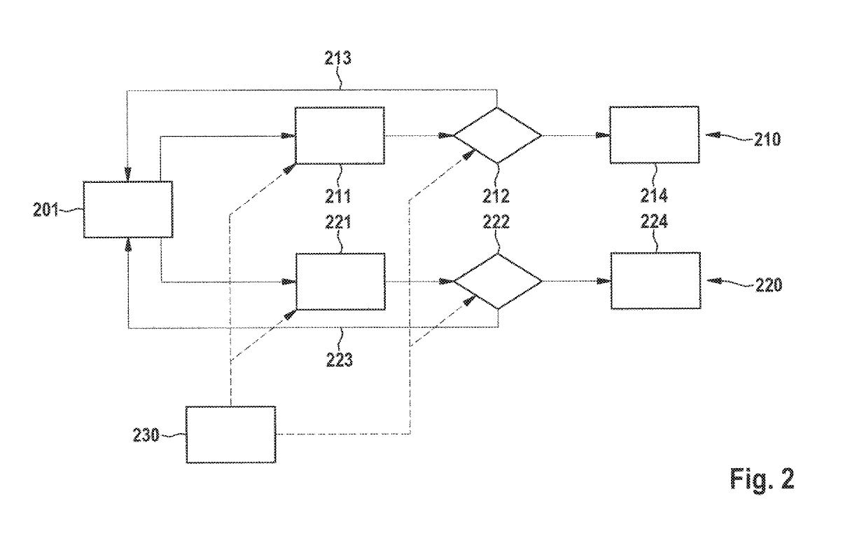

Control unit 110 is in particular designed to carry out a specific embodiment of a method of the present invention, which is shown schematically in FIG. 2 as a block diagram.

In step 201, snowmobile 100 is operated in a regular operation on snow-covered alpine terrain. In the course of this regular operation, measured values of various measured variables are determined.

Rotational speed sensor 131 is used to determine rotational speed values as measured values for a rotational speed of internal combustion engine 110 as measured variable.

Rate-of-rotation sensors 132 are used to determine measured values for yaw angles, pitch angles and roll angles and yaw rates, pitch rates and roll rates as measured variables.

Acceleration sensors 133 are used to determine measured values for the movement or direction of movement of snowmobile 100 as measured variables. This direction of movement as a measured variable in particular describes whether the snowmobile moves uphill, downhill or crosswise with respect to a gradient. In particular, an angle is determined between the longitudinal axis of the snowmobile and a direction of a gradient of a hillside as measured value for the direction of movement.

GPS sensor 134 is used to determine measured values for characteristics of the terrain. These terrain characteristics describe in particular the terrain on which snowmobile 100 is operated, for example a terrain gradient. GPS information of GPS sensor 134 is used in particular to analyze topographical map information or map data in order to determine measured values for terrain characteristics. Such map information or map data may be stored for example in control unit 120.

Steering sensor 135 is used to determine measured values for a steering direction as measured variable. The steering direction indicates in particular in which direction steering 105 is steered or at which angle skis 101 and 103 are steered with respect to the longitudinal axis of snowmobile 100.

Weight sensor 136 is used to determine measured values for a weight load on seat 107 as measured variable. This weight load describes in particular a body weight of the driver of snowmobile 100.

Steps 210, according to a specific embodiment of the present invention, monitor whether the snowmobile is operated in such a way in a first unstable driving state that there is the risk that the snowmobile tips over to the left.

For this purpose, a first combination of measured variables is monitored in step 211. As the first combination, the steering direction, the direction of movement, the rotational speed and the roll angle are jointly monitored.

In step 212, the measured values detected in step 201 for the steering direction, the direction of movement, the rotational speed and the roll angle are evaluated on the basis of first evaluation criteria as to whether snowmobile 100 is operated in the first unstable driving state.

For example, an evaluation is performed in step 212 as to whether the steering direction exceeds a specific limit value, for example whether the skis are steered at an angle greater than 25° (counterclockwise) with respect to the longitudinal axis of the snowmobile. Furthermore, the system monitors whether the rotational speed exceeds a limit value, for example 2000 r.p.m.

The system furthermore monitors whether the direction of movement in relation to the gradient of the hillside exceeds a limit value. For this purpose, for example, the system monitors whether the angle between the longitudinal axis of snowmobile 100 and the direction of the gradient of the hillside exceeds an angle of 45°. In this case, snowmobile 100 is moved crosswise with respect to the gradient of the hillside.

The system furthermore monitors whether the roll angle deviates from a reference value by a specific measure. This reference value is selected as a function of the rotational speed detected in step 201 and the steering direction detected in step 201 and is characteristic for this rotational speed and this steering direction.

This reference value describes in particular a cornering behavior of the snowmobile when the snowmobile is operated without loads, that is, without a driver, without a passenger and without luggage or freight, at the rotational speed detected in step 201 and the steering direction detected in step 201.

If the roll angle deviates from the respective reference value, then this means in particular that the driver of snowmobile 100 shifts his weight unevenly while cornering. If the roll angle deviates from the respective reference value by more than the specific measure, then this means in particular that the weight of the driver is distributed in an uneven manner.

If a specified minimum number (in particular all, or e.g. all except one) of these limit values is not reached or if a specified minimum number (in particular all, or e.g. all except one) of these first evaluation criteria is not fulfilled, then a determination is made that snowmobile 100 is not operated in the first unstable driving state. In this case, according to step 213, measured values for the steering direction, the direction of movement, rotational speed and roll angle are determined anew.

If, by contrast, the specified minimum number of these limit values is reached or if the specified minimum number of these first evaluation criteria is fulfilled, then a determination is made that snowmobile 100 is operated in the first unstable driving state. In this case, a first stabilizing countermeasure is taken in step 214. For this purpose, control unit 120 controls an actuator 137 at the spring suspension 104 of the left ski 103 via CAN bus 121. Snowmobile 100 is thus raised on its left side. Furthermore, control unit 120 as a countermeasure reduces the rotational speed of internal combustion engine 110, for example to 1000 r.p.m., which reduces the speed of snowmobile 100.

The system in particular may furthermore monitor—mutatis mutandis—whether the snowmobile is operated in an unstable driving state in such a way that there is the risk that the snowmobile tips over to the right.

Steps 220, according to a specific embodiment of the present invention, monitor whether the snowmobile is operated in such a way in a second unstable driving state that there is an increased risk of an accident due to excessive speed.

For this purpose, a second combination of measured variables is monitored in step 221. As a second combination, characteristics of the terrain, the direction of movement and the rotational speed are monitored.

In step 222, the measured values recorded in step 201 for the terrain characteristics, direction of movement and rotational speed are evaluated on the basis of second evaluation criteria as to whether snowmobile 100 is being operated in the second unstable driving state.

In step 222, for example, the system monitors whether the characteristics of the terrain exceed a specific limit value, for example whether the gradient of a hillside exceeds a value of 33%.

The system furthermore monitors whether the direction of movement in relation to the gradient of the hillside exceeds a limit value and whether the direction of movement is directed downhill. For this purpose, for example, the system monitors whether an angle between the longitudinal axis of snowmobile 100 and the direction of the gradient of the hillside falls below an angle of 25°. In this case, snowmobile 100 is moved approximately parallel to the gradient of the hillside in a downhill direction.

Furthermore, the system monitors whether the rotational speed (which may be at the output side of the transmission) exceeds a limit value, for example 1000 r.p.m. This limit value for the rotational speed according to the second evaluation criteria differs normally from the limit value for the rotational speed according to the first evaluation criteria according to step 212.

If a specified minimum number (in particular all, or e.g. all except one) of these limit values is not reached or if a specified minimum number (in particular all, or e.g. all except one) of these second evaluation criteria is not fulfilled, then a determination is made that snowmobile 100 is not being operated in the second unstable driving state. In this case, according to step 223, measured values for the terrain characteristics, the direction of movement and the rotational speed are determined anew.

If the specified minimum number of these limit values is reached or if the specified minimum number of these second evaluation criteria is fulfilled, then a determination is made that snowmobile 100 is being operated in the second unstable driving state. In this case, a second stabilizing countermeasure is taken in step 224. Control unit 120 for this purpose reduces the rotational speed of internal combustion engine 110, for example to 500 r.p.m. Control unit 120 furthermore outputs a warning to the driver as a second countermeasure, activating for example a warning light in a dashboard area of snowmobile 100.

The first and the second combination of measured variables as well as the respective first and second evaluation criteria are determined in the course of a manufacturing process or a test phase 230 of snowmobile 100. In this test phase, snow mobile 100 is examined for example experimentally and theoretically with respect to the risk of an accident and the risk of tipping over. In the course of this test phase 230, a determination is made that it is possible reliably to infer the first or, respectively, the second unstable driving state on the basis of the first or, respectively, the second combination of measured variables and the respective first or, respectively, second evaluation criteria.

In particular, in the course of this manufacturing process or the test phase 230, different cornering tests of snowmobile 100 are performed without load, that is without driver, without passenger and without luggage or freight, at different rotational speeds and steering angles. In the process, measured values are determined for the roll angle as corresponding reference values.

1-12. (canceled)

13. A method for operating a snowmobile, the method comprising:
determining measured values of measured variables of the snowmobile in a continuous operation of the snowmobile;
evaluating specific measured values of different combinations of individual measured variables of the snowmobile based on evaluation criteria as to whether the snowmobile is being operated in an unstable driving state; and
implementing a stabilizing countermeasure if it is determined that the snowmobile is being operated in an unstable driving state.

14. The method of claim 13, wherein the determined measured values of the different combinations of individual measured variables of the snowmobile are evaluated based on the evaluation criteria in that a check is performed to determine whether the determined measured values of the individual measured variables of the different combinations respectively reach an associated combination-specific threshold value.

15. The method of claim 14, wherein a determination is made that the snowmobile is operated in an unstable driving state if the determined measured values of the individual measured variables of one of the different groups respectively reach the associated combination-specific threshold values.

16. The method of claim 13, wherein components of the snowmobile are controlled as a stabilizing countermeasure so as to counteract the unstable driving state.

17. The method of claim 16, wherein, as a stabilizing countermeasure, a drive torque provided by a drive of the snowmobile is limited, a rotational speed of the drive of the snowmobile is limited, a voltage and/or a current for an electric motor as the drive of the snowmobile is limited, a spring suspension of the snowmobile is adjusted, a brake of the snowmobile is actuated and/or a radius of curve of the snowmobile is limited.

18. The method of claim 13, wherein measured values are determined of movement-specific measured variables, which describe a movement of the snowmobile, of orientation-specific measured variables, which describe a spatial orientation of the snowmobile and/or of terrain-specific measured variables, which describe a terrain, on which the snowmobile is operated.

19. The method of claim 13, wherein a grouping of the measured variables into the different combinations and/or the evaluation criteria is determined experimentally and/or theoretically in the course of a manufacturing process of the snowmobile.

20. The method of claim 13, wherein the grouping of the measured variables into the different combinations and/or the evaluation criteria are determined in the course of the continuous operation of the snowmobile.

21. A processing unit for operating a snowmobile, comprising:
a determining arrangement to determine measured values of measured variables of the snowmobile in a continuous operation of the snowmobile;
an evaluating arrangement to evaluate specific measured values of different combinations of individual measured variables of the snowmobile based on evaluation criteria as to whether the snowmobile is being operated in an unstable driving state; and
a stabilizing arrangement to implement a stabilizing countermeasure if it is determined that the snowmobile is being operated in an unstable driving state.

22. A snowmobile, comprising:
a processing unit for operating a snowmobile, including:
a determining arrangement to determine measured values of measured variables of the snowmobile in a continuous operation of the snowmobile;
an evaluating arrangement to evaluate specific measured values of different combinations of individual measured variables of the snowmobile based on evaluation criteria as to whether the snowmobile is being operated in an unstable driving state; and
a stabilizing arrangement to implement a stabilizing countermeasure if it is determined that the snowmobile is being operated in an unstable driving state.

23. A computer readable medium having a computer program, which is executable by a processor, comprising:
a program code arrangement having program code for operating a snowmobile, by performing the following:
determining measured values of measured variables of the snowmobile in a continuous operation of the snowmobile;
evaluating specific measured values of different combinations of individual measured variables of the snowmobile based on evaluation criteria as to whether the snowmobile is being operated in an unstable driving state; and
implementing a stabilizing countermeasure if it is determined that the snowmobile is being operated in an unstable driving state.

24. The computer readable medium of claim 23, wherein the determined measured values of the different combinations of individual measured variables of the snowmobile are evaluated based on the evaluation criteria in that a check is performed to determine whether the determined measured values of the individual measured variables of the different combinations respectively reach an associated combination-specific threshold value.
